(19) United States
(12) Patent Application Publication
(10) Pub. No.: US 2005/0086139 A1
(43) Pub. Date: Apr. 21, 2005

(54) Credsub (credit subscribing) EEECI (easy economical enhancing credit innovation) or new economical enhancing credit innovation (NEECINN/NEECIN):

(76) Inventor: Lee Blackman, Brooklyn, NY (US)

Correspondence Address: Lee Blackman, 601 Park Place, Brooklyn, NY, 11238, US

(21) Appl. No.: 10/389,594

(22) Filed: Oct. 21, 2003

(51) Int. Cl. G06F 17/60

(52) U.S. Cl. 705/35

(57) ABSTRACT

Subscribing Credit plans with unlimited and limited life with a Paperless electronic checking system, electronic checkbook, credit card system with a utility card carrying four digits, with disposable or static numbers, using a personal software dialer/connect to login to a web template for fraud-less transaction. Purchase and or lease Credit without interest or with interest at a fix or unfix APR renewable. Credit increase by purchasing higher plans. Payment on outstanding balance over $50 is 2%-5% minimum, balance $50 and under is 25%-50%. Security feature (Checkact) that lock and unlock checks or financial card. Escrow features certify checks and allowed the payee to deposit it without using a bank teller or entering the bank. PYN prevents payee and payer from seeing each other account number on the check. Account has no accruing interest on outstanding balance. C-pay allows payment through any, Credsub issuer.

### BACK GROUND OF THE INVENTION

Present invention relate to credits, particularly those credits that are personal lines of credit and credit card. More particularly, the invention relates to subscribing credit plans with a single system for credit cards with a secondary card (utility card), credit check (credit advance checks), and a checking account line of credit with a paperless Electronic Check (Lfee) as a single unit or bundle service.

Creditors do not have credit plans, for borrowers to choose a service plan with or with out accruing interest on outstanding balance. Credit card and checking account numbers can be easily stolen from the check or card and on the Web. Some personal line of credit requires the borrower to write checks from the line of credit account to a separate account every time funs are needed from the line of credit account.

Zero (0%) APR introductory rate on credit card, only applied to new accounts and balances transfer from other accounts. Introductory rates are none renewable, account must be in good standing during the introductory period, if not, you will pay a higher interest rate.

Check number and amount cannot be lock or unlock by the account-holder. The complete paper check is scanned in order to become an electronic check. Paperless electronic check and electronic checkbook is not yet on the market. Payments cannot be made with a lender that did not issued the credit account. Payment received on outstanding balance on traditional credit account goes towards the first purchase or first use of the credit, (first in first out) unless stated in writing by the payee. Interest Payment on outstanding balance varies with the daily periodic rate (DPR) unless it is a 0% APR introductory fix rate.

### BRIEF SUMMARY OF THE INVENTION

It is an object of the invention to provide Subscribing credit with term life (Tcredit). A method for implementing such a system is a credit plan system that can be used for credit cards with or without a secondary card (utility card), credit checks (credit advance checks) and a checking account line of credit (Lfee) as a single unit or bundled service. A subscriber can choose a credit plan with or without accruing interest on outstanding balance, with an unlimited or limited life. Example a working life of 3 years or a 3 year life (3Tcredit) with a renewable process. Lfee is a paperless Electronic Check, with a checking account line of credit. There is no deposit require to cover written checks unlike traditional checking account. Checks are certified without using a bank teller or entering the bank. There is no credit increase with Credsub line of credit year after year unlike conventional credit card line of credit. Even if the account is a credit card account. Credit is increase by purchasing higher plans, if qualify. Payment on outstanding balance over $50 is 2% -5% minimum, balance $50 and under is 25%-50% minimum. Payments can be made with any lender that issue Credsub account using a Cpay slip and your PYN. Payer number (PYN): is a special standardize number (ID) or USFIN (Universal Standardize Financial Identification Number). The number is use for financial transaction, e.g. Bank deposits, payment on credit accounts, loans and mortgage etc. or identity theft account (ITA). When Lfee is link with a credit card, there is no late payment or bounce check. A 4 digit credit card with a personal software connector or dialer. There is no first in first out payment on outstanding balances, or accruing interest on outstanding balance. However, cash advance and bonuses may have accruing interest and first in first out payment.

Checks or financial cards can be lock or unlock by a payer, to prevent someone from gaining access to his cash or preventing the check from being cleared or cash by using Checkact. A four-digit Credit card.

The foregoing and other objects, features, and advantages of the invention will be visible from the following description of preferred drawings of the invention as illustrated in the accompanying drawings.

### BRIEF DESCRIPTON OF THE DRAWING

FIG. 101 is a diagram showing a regular Lfee check (Subcheck) without a magnetic strip, with routing #, transit #, PYN/ID # 3210 75 668468 99871622011, ATV number, check number and UPC number, that will be hidden under the magnetic strip, and where to activate the check if needed.

FIG. 102 Is a diagram showing a magnetic strip covering the Routing #, Transit #, PYN/ID, serial/ATV number and check number and a dollar sign in front of the box (magnetic box optional), for writing the amount at the bottom of the check for scanning.

FIG. 103 Is a diagram showing a paperless electronic check, an awaken check (Sleepy Check/Lazy Check), after a Lfee paper check or Lfee ID is scanned, and a copy of a printed paperless check in the form of a receipt after a tansaction has been process and approved awaiting the payer signature for approval.

FIG. 104 is a diagram showing a Cpay slip, for making payment at any Credsub/Lfee issuer.

FIG. 105 is a diagram showing multiple bundled service plans with a fix amount for credit card with cash advance checks, with 1 to 3 Tcredit, 0% APR and zero bonus.

FIG. 106 is showing multiple service plans with 1 to 3 Tcredit, for credit card or Lfee checking account, with 0% APR and zero bonus.

FIG. 107: is a diagram showing multiple bundled Service plans that can be use for credit card or Lfee checking account, with working life 1 to 3 year (Tcredit), and bonus access at 3.99% APR.

FIG. 108 is showing multiple service plans with limited or unlimited life, zero bonus and 5.99% APR, that can be used for Lfee checking account or credit card with cash advance check for the entire amount.

FIG. 109 is a diagram showing the view of Lfee (Subcheck) when it becomes an Escrow check.

FIG. 110 is a diagram showing multiple bundled Service plans with a credit card account carrying a fix amount for secondary card, cash advance checks and bonus access with 5.99 % APR for 1 to 3 years.

FIG. 111 is a diagram showing a Lfee software template dialer/connecter dialog box for end user input, to make direct Internet connection to the network as the owner or visitor/guest to the computer use for connect to the Internet, using a pass word or PIN number.

FIG. 112 is a diagram showing a web template with a dropdown menu using two different types of secondary cards on the Lfee network (web site). With an option to choose the type of card for making payment or purchases, depending on the plan chosen.

FIG. 113 is a diagram showing a web template with a dropdown menu listing all of the end user utility suppliers (Companies), PYN/USFIN and the Ufix (U-fix) card number, when connected to network.

### DETAIL DESCRIPTION OF THE INVENTION

Referring now, more particularly, to the drawings, indicate the structural features in the various diagrams and service plans with a credit subscribing system where by someone can purchase and or lease credit with an unlimited life or limited life e.g. 3 years (term life credit), without interest or with interest at a low fix or unfix APR. Credsub can be offered without the leasing or purchase process.

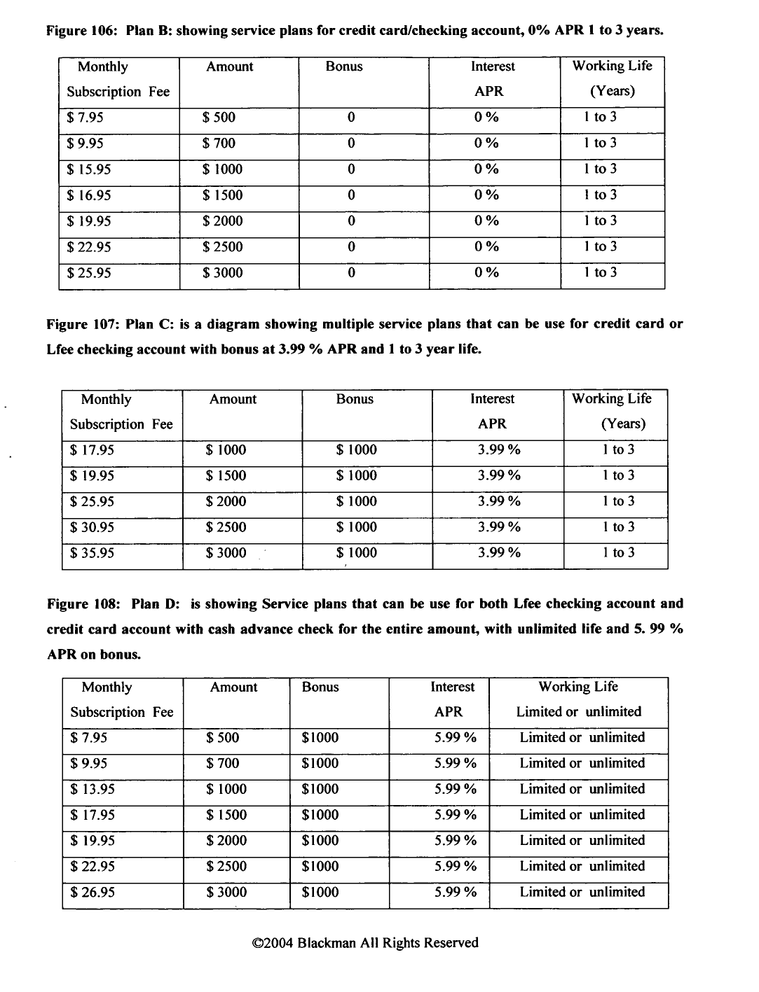

Credsub (credit subscribing) or Lee Financial Economical Enhancement (Lfee): Is a subscribing system that comes in two flavors, Checking System (Lfee/Subcheck) and a credit card system or Easy Economical Enhancing Card (EEE Card/Lfee card). Each one can be used independently with its own features and tools. Credsub does not carry a publish account number unlike conventional credit cards or checks, it uses a PYN/USFIN that link it to the account number. Checks written on the account is not subject to cash advance fee or transfer fee. Every account holder is required to pay a subscription fee for a fix amount of credit, using a service plan (LaLoo plan). See FIGS. 105-108 and FIG. 110. There is no accruing interest on outstanding balance or deposit made to start an account. However a lender may offer extra credit as a bonus. Any outstanding balance on the bonus amount is subject to accrued interest, when part or whole bonus is used. Payment on outstanding balance over $50 is 2% -5% minimum, balance $50 and under is 25%-50% plus the subscribing fee. Accounts are setup or activated over the counter/store front, but not by the lenders.

Lfee credit card account has the option of carrying a secondary card (utility card) with a four-digit number, but it can carry 3-10 digits. The secondary card comes in two flavors, a fix number (Ufix card/utility fix number) and disposable number (UD/UDcard). The card feeds on the primary account. But can be setup as a separate account, or as an extension (add-on) to conventional credit card, savings or checking account, by using the last four digits of their account numbers as a Ufix number, with access to a limited amount in the account or full access to the total account. The utility card is designed for Internet transaction such as rent, utility bills, mortgages and repair fixtures on the mortgage home, and Subscription payments. When used for making ISP (Internet Service Providers) payments or subscription payments, each payment is billed three (3) times the amount, e.g. $20 subscription will be billed $60 (quarterly billing). Mortgage card (Lfee m) is setup against the down payment on the building.

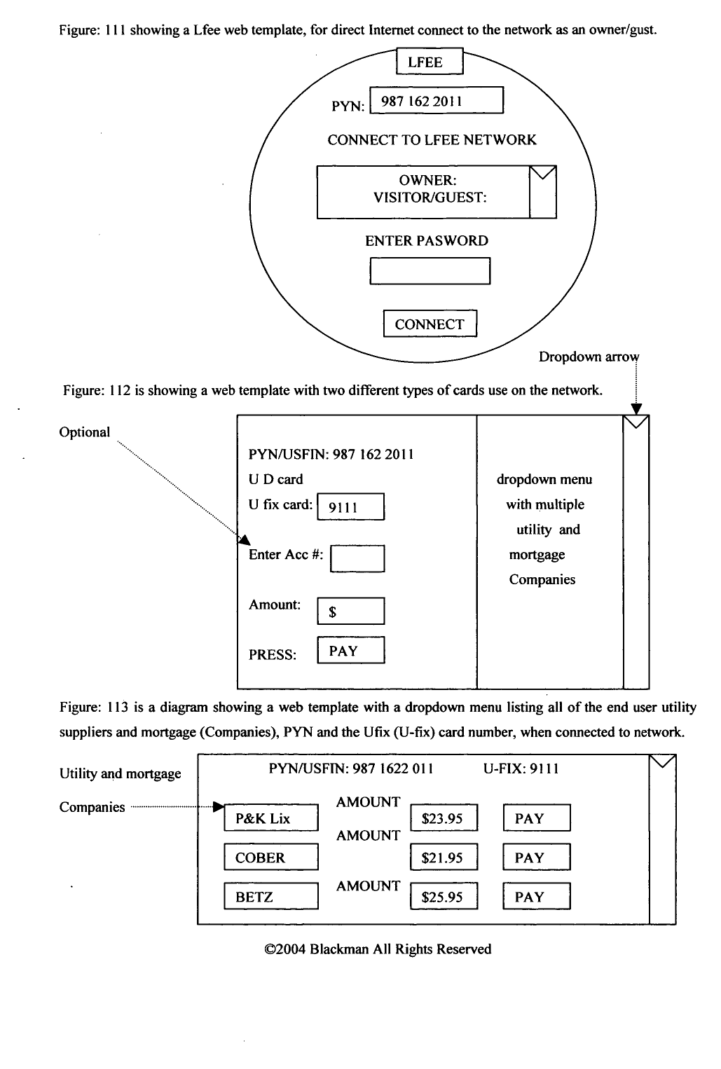

How does Lfee secondary card (utility card) work: The card works with a software setup dialer or a web template software connecter on any computer as an extra security feature, with a PYN/USFIN and a PIN number or password to login to the Lfee network in order to make fraud proof transaction. See FIG. 111. After the account is setup, a user will double click the Lfee personal software connecter/dialer icon, it will take him to a dialog box where the end user can connect to the network as the owner or as a visitor/guest to the computer used to connect to the Internet, using a password or PIN number (optional). See FIG. 111. The software setup package is architecture to automatically prompt the cardholder ISP dialer to connect to the Internet, directly to the network (Lfee.com). Or you can connect to the Internet with your ISP, then click the minimize button, then double click the Lfee icon, which will take you to the Lfee network to enter your password or PIN number. See FIG. 111. When login to the network, you will be taken to FIG. 112 or FIG. 113 depending on the end user plan chosen, the cardholder can enter his card number e.g. # 9111 manually or it can be static on the end user web template as UD or Ufix card. Web transaction can also be made by replacing owner, visitor/guest with Ufix and UD card, enter password would replace with enter card number using FIG. 111. When connect is click, it goes to the bank/lender linking it to the bank systems which verify the card number with the PYN/USFIN authenticity and identify the user by matching the card number with the PYN/USFIN. The PYN/USFIN identify the user and the card number identity's the bank/Lender on the Web. The card number is like a pointer, when connect is click it prompts the respectful lender number e.g. (transit/routing #) hidden in the back ground to link with the banking systems. To make a general purchase on the web, the cardholder will click Lfee on the payee web site, which would prompt the Lfee personal software connecter to popup on his computer automatically to connect to the Lfee network. See FIG. 112, on the left side enter acc# would be replace with enter card number, the right side would be replace with the payee name, address, PYN and Lfee license number. With Lfee card the merchant only gets to see the user four digits on the card and at no time will see his account number. A Lfee account cash advance check amount is link to a conventional checking account that has a zero monthly maintenance fee, in order to avoid penalty for accounts that are none transferable, or a deposit is required to start the account e.g. $5 or 5 to 10% of the credit amount approved (optional). The account will have automatic withdrawal from the amount allowed for cash advance checks and bonuses into the conventional account. The line of credit must be approved before making the deposit or opening the conventional account. Deposit made to start the account is none accessable, interest bearing and none withdrawal until the end of the term. But will be part of the account depending on the lender, accounts may have interest bearing as an option.

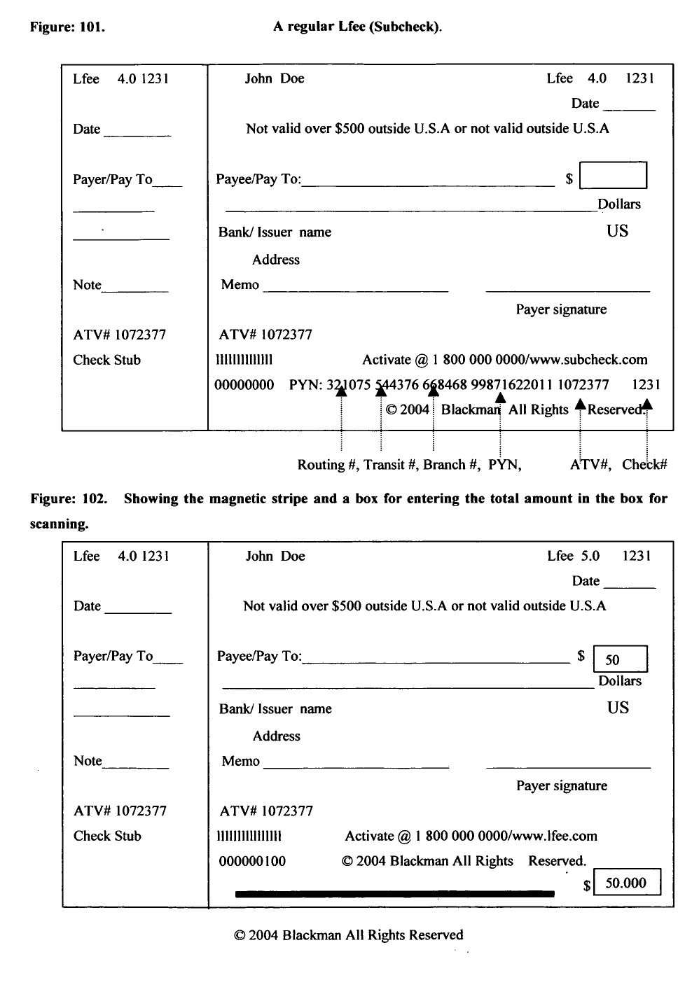

Lfee check comes in two flavors, paper check and paperless Electronic Check, with a Checking account line of credit or a conventional checking account joint with a line of credit to form a single account. Example, you can take a line of credit to open a Lfee account and used some of your own funs to start the account e.g. $5 or 5-10% of the amount (optional). The total line of credit will automatically be the total amount of the checking account. The amount can be automatically link or deposit to the account after the applicant deposits some of his own funs to start the account. Or a single check can also be written for the total amount of the credit line and deposit into the account, making the account automatically a single account. When a Lfee ATM card is used to get cash, a fee and or accruing interest may apply on the balance. There is no minimum balance required on the account. All payment received on outstanding balance will be credited to the Lfee account. A Lfee account comes with zero accruing interest with a limited life e.g. 1 to 3 years or unlimited life. If there is an outstanding balance on the account at the end of the term, the Issuer or lender will use part or whole deposit to pay off outstanding balance. A Lfee ID access the electronic checkbook dater base, awaken the check from its sleep (Sleepy Check/Lazy Check) forming a paperless check that display automatically on the cashier screen or convenient universal payment machine (CUPM). When process and approved, it print's a receipt in the form of a check, with a number not yet publish on the paper checks or Checkbook. Lfee checks numbers does not run in numeral order unlike regular checks e.g. 1012, 1013, and 1014, optional. Lfee check is also a check that is paid of a checking account that do not required the account holder to make any deposit in his account for the check to be drawn against it during the Tcredit. Lfee comes with a Routing #, Transit #, PYN/ID, serial/ATV number, check number and UPC number. See FIG. 101. The check numbers will be hidden under the magnetic stripe, and may not seen as shown, depending on the version. See FIG. 102. The check bears the holder name without his street address as an extra security (optional).

Each serial or ATV number would be different and does not run in numeral order unlike check numbers. Lfee can also be custom tailored for private labeling (private labeled check/PLC). Lfee can also be use as a universal personal or business check (Gcheck or GOcheck (global check).

To obtain a Lfee account, you must choose a Laloo plan and apply for credit or ask your credit card issuer to used part or whole credit card account to establish a Lfee checking account. A credit check and a fee may apply. An application-processing or activation fee may also apply. Accounts may have a yearly automatic access, renewal and or an analyzing process (optional), but if apply a fee may also applied. If canceled before the turm, a penalty may apply for early cancellation. Checks can be pre written e.g. not valid over $500 or outside the U.S.A. See FIG. 101. Purchase and subscriber fees vary on amount. When part of a credit card account is bundled with or used to open a Lfee account, it may reduce the credit card credit line of credit depending on the Lender. Lfee can be architecture to link with a regular credit card account e.g. If you write a check for $100 and your account have a $25 balance. The issuer will pay the other $75 or $100 and charge it to your credit card to avoid returned or bounce check. Issuer may required a sign agreement to reserved a special amount of your credit line from your credit card issuer for your Lfee account. You will be bill by your credit card issuer each time the Lfee issuer charge you account for such service. Or you will be presented with a monthly statement or invoice for payment. If a Lfee account is link to a credit card, your transactions are credit card purchases, not cash advances. There are no first in first out payment on Credsub accounts, because there is no interest charge to the account. Cash advance and bonuses may have first in first out payment apply. Lfee account is a none-depositing account, any deposit receive or made to the account will be treated as a payment. If the account has no outstanding balance, it would be treated as a credit towards the account. A Lfee check is not a traditional check with cash in the account, for checks written on the account to be drawn against it. It is a Subcheck or credit check, neither the check nor its balance is cash. The purchaser is promising to pay later with money, this is the reason why he may signs a promissory note and both he and the payee keep a copy. A percentage of all purchase made will be put aside as a bonus (purchase bonus). At the end of each term, if there is an account balance, it will be used as a payment towards the account, if there is no outstanding balance, it becomes void automatically.

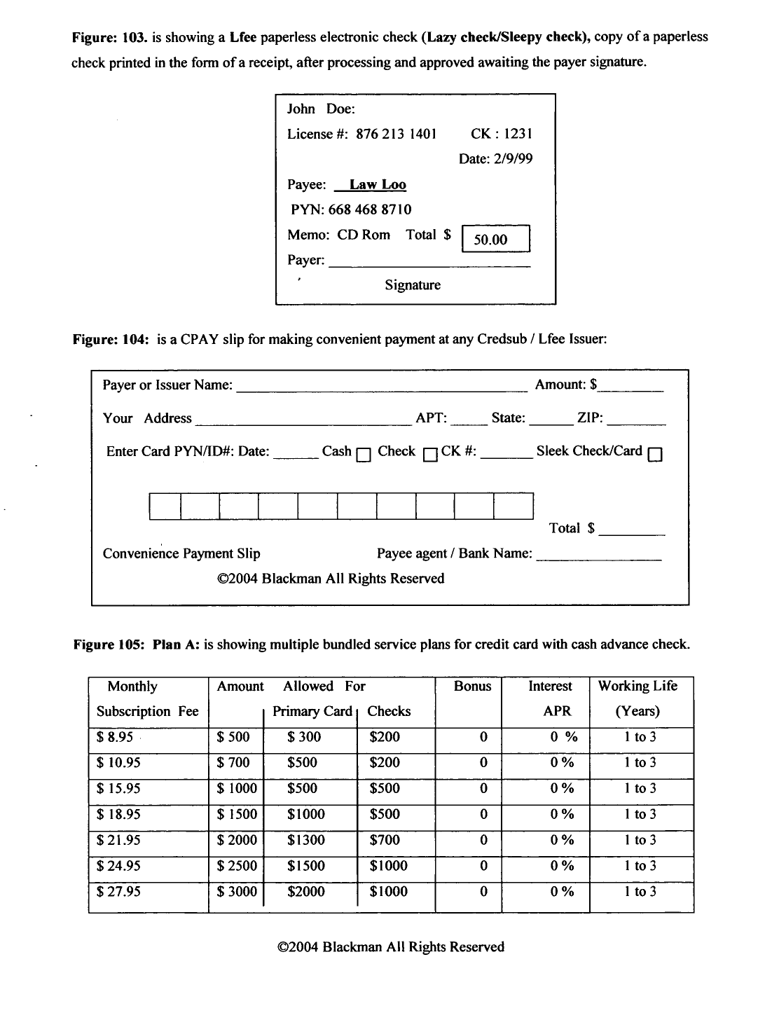

How does Lfee check work: To make a purchase, the checkholder will write the payee name, amount of the purchase and his signature on the check. Depending on the version, he will write the amount in the box at the bottom with the magnetic stripe for scanning and or at the top. See FIGS. 101-102. When the check is scanned, the routing #, transit #, Branch # or private labeler #, PYN, serial/ATV # check # and the cash amount written at the bottom are scanned from the magnetic stripe. If the amount written cannot be scanned, the cashier will enter the amount manually. The cashier can also scanned any of the following using a CUPM or credit card machine, the UPC #, magnetic stripe with the amount on the check, check holder ID, the numbers at the bottom of the check or enter the numbers with or without magnetic ink and amount. See FIGS. 101-102. After scanning, follow the prompts and press enter, see FIG. 103, enter signature. The cashier will press enter again, to retrieve the payer's electronic signature from the dater base where it has been stored by the account issuer during the application process. It will automatically appear on the check image on the line next to payer signature on the cashier's screen. See FIG. 103. The payer has an option of entering his PIN number. The payer can also use a signature pad, then press enter. When enter is press, it will send the signature from the pad onto the check image on the screen, making it a completed check with a signature. The Cashier will press enter, sending the image of the paperless Check or the information entered in/on the image electronically to the merchant Bank for processing. The check guarantee processor will also have an electronic check Image to receive the paperless check information from the merchant on behalf of the merchant bank. The date and payee name/Licensee #, will automatically entered on the image of the check. There is no need for any other signature. But when process and approved, it will print a check in the form of a receipt with a line asking for the payer signature on the receipt (Sleepy Check) as a form of accepting the transaction. See FIG. 103. If the numbers are entered manually or scanned, the same check number will be printed. When a Lfee ID is used or scanned, the receipt will also be printed in the form of a check, awaken it from its sleep (Sleepy Check/Lazy Check), with a check number not yet publish on the paper check/Checkbook. The cashier will enter the cash amount of the purchase then press enter. The payer signature will automatically retrieved from the database and place next to payer signature. See FIG. 103, cashier can press enter to process the check or cancel to void the transaction. If she gets an approval e.g. $50, the $50 will be moved from the holder's account into the merchant's bank account within a given time e.g. 24 to 48 hours.

Checks are Process and Paid: in three ways. (1) When a purchase is made in person and any of the following is scanned, check UPC number, the magnetic stripe on the check or Lfee ID. Or the numbers at the bottom of the check entered manually by the Cashier, then process through a credit card machine or CUPM for payment with the payee merchant bank guarantee processor for the amount that is written on the check. If approved, the merchant will stamp his or Company name on the check, or the cashier can place the check into the receipt printer to be printed with the word Void or used, then give it back to the payer. After processing and approved, the amount will be posted to the merchant account as cash. (2) When an individual is paid with a check, he can present it to his bank for processing through their check guarantee processor on the payees behalf for a fee equal an ATM charge (optional). After processing, the bank will send it to the issuer to be sent to the account holder (optional). (3) When a Lfee Escrow Check is activated on a payee account or PYN and is as unavailable funs until the check is deposit by the payee within a given time depending on the lender and is Process with a check guarantee processor (clearing-house) or cleared by a central bank or FRB (Federal Reserved Bank) as regular check. Convenience Payment/CPAY: Making payment at a financial institution that did not issued your Lfee account for a fee equaling an ATM charge. To make a payment at the none-account issuer, a payer will fill out a CPAY slip with his name, date, payment number (PYN) and total amount paying, address (optional) see FIG. 104.

Checkact: is a security feature/process that act as a key to lock and unlock a check or financial card allowing it to have access or from gaining access to the cash/credit in the account.

Using a PYN, serial or ATV number to allowed a check/card number and total amount that is available to the card or written on the check, to make available when the card is used or check is deposited. Or make the cash/credit available for the specific card/check number to be used or drawn against or cleared. By using this security process, in case the check/card is loss or stolen, no one will have access to your cash or credit. The payer himself will be doing most of the effects, instead of the bank/lender. A cash amount must be entered in order for a check or card to be activated e.g. $50. If $60 is activated and only $50 is used the other $10 would automatically remain in the account and a fee may apply (returned or unused fee). The account holder address is optional, if altered the check will have another security boost.

To activate a card/check or bring it to life, you must enter the PYN/ID# or Account number, ATV/serial number, card/check number, the cash amount you want to put or allowed on the card or write on the check depending on the type, your PIN/ID# and or zip code using a phone, CUPM, ATM or the web and press enter. Checkact can be architecture in a way that when activated you can receive an activated number. When a check/card is activated the total amount activated will automatically be subtracted from the account e.g. an account balance of $60 with an activated $50 will leave the account with a $10 balance. The $50 wilt be unavailable fun because it moves to perform a transaction that is not yet paid for.

A Lender can use in house or out house credit card to pay or link to a Credsub account.

An In house lender: Is a lender that provides funs or credit for a Credsub account and used a credit card or other account issued by the same bank or lender, to pay for charges on the account.

An Out house Lender: Is a lender that provides funs for a Credsub account and used a credit card or another form of payment from another issued to pay for charges on the account.

A Lfee applicant cannot customize a fix amount of credit unlike a traditional personal line of credit. He may choose a plan or the lender may assign the credit worth of a pre customize service Plans. See Lfee service Plans examples in FIGS. 105 to 108 and 110. Some plans are design for credit card and Lfee checking account. Lfee credit line does not increase unlike a credit card account year after year. However a holder may purchase additional credit by moving to a higher plan (fee optional). A lender may add a low accruing interest on an extra amount of credit as a bonus to a subscriber plan. See FIG. 107.

Escrow Check or Early Deposit Check (EDCheck): Is an advance process that is added to Lfee to allow an account holder to certified his own check without using a bank teller or entering in a bank. You can also deposit the check without having it in your position, seeing it or endorsing it or without putting your feet in the bank, check the financial status of the amount or find out if the check is activated using the PYN/ID number, serial/ATV number, check number and the total cash amount written on the check. An account at a bank and access to one of the following, CUPM (Convenient Universal Payment Machine), phone, web, ATM or credit card machine and follow the prompts. Escrow check works with Checkact system (Checkact activation system).

Regular Checks: Are paid when deposited and cleared by a clearinghouse or when process on a CUPM or credit card machine.

Escrow Check or Certified Check: Is a check that cannot be cancel by the payer. It is a process by which a bank or issuer moves fins from a Lfee account for or as future payment to a third party account. If the third party does not deposit the check within a given period e.g. 21 days from the date the escrow started, the escrow will be reverse into the holders account and a service fee/penalty apply for moving (2 ways, 3^{rd} party only). The payer and the payee will be charge a one time service fee when the check is deposited. Payer, purchase fee, payee transfer/deposit fee, both fees would be the same amount. Or they both can be enrolled or subscribe to Checkact and escrow monthly service (escrow service) for a fee.

Escrow fee: A monthly subscription or service access fee charge by a Lfee issuer to be on the Escrow network, to allow an account holder to Certify his own checks. An account holder must subscribe to the

Escrow and Checkact network in order to have access to those features for the process to take place.

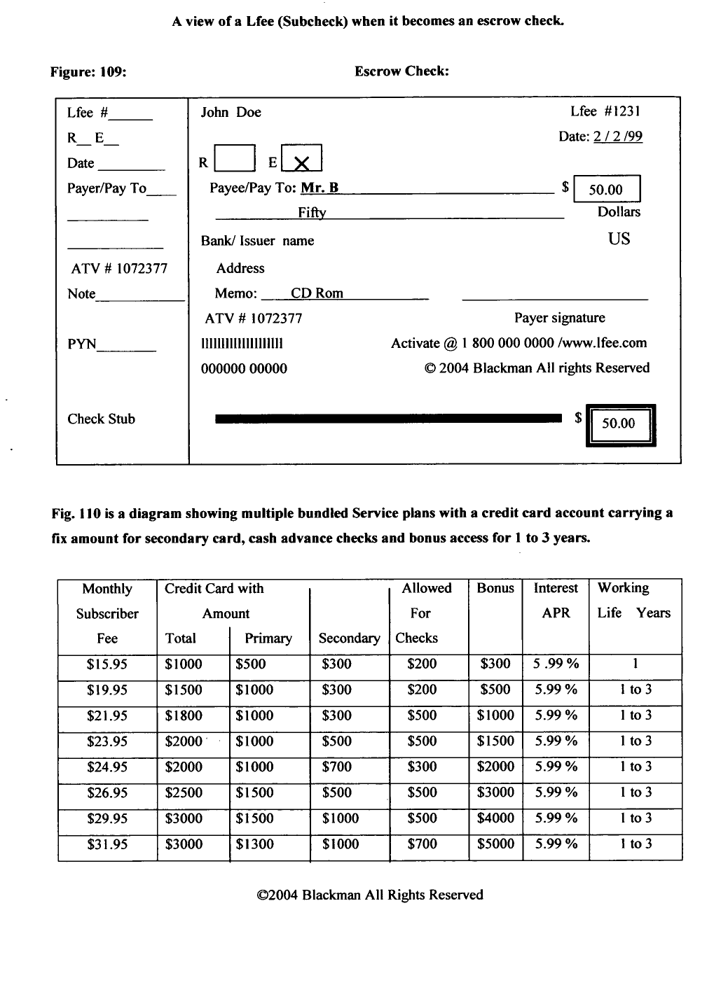

How an Escrow Check works: An escrow check works with Checkact using one of the following, a CUPM, a phone, web, ATM or credit card machine. Mr. A is an example, he leaves in New York and he is a subscriber of Lfee with Escrow features, he order a CD Rom that cost $50 from Mr. B who is a merchant in Washington DC. Mr. B said he wants a certified check of $50 before he can ship the product. Mr. B gave Mr. A, his Company PYN # to activate the check on. Mr. A writes a check for $50 then put an X in the box mark E see FIG. 109 and activate it on Mr. B Company's PYN/ID# with $50 using his CUPM or the web, an ATM or phone, then gives or tell Mr. B the check number and amount. Mr. B can choose to use his CUPM, an ATM, credit card machine, web or phone and enter his company PYN/ID number and PIN#. If the activation was approved he will see or hear $50 is or was activated to your account or PYN # with the date. By following the prompts, he can deposit the check by press a letter or number. The issuer will move the total amount of the check ($50) to Mr. B's bank account, but will be in the account as unavailable fun until Mr. B deposits the check within a given period. A certified check may have the box/space C/E mark; a regular would mark R or leave blank. Mr. A will mail the check to Mr. B (optional). See FIG. 109. By putting a C/E in the box and activate it on Mr. B Company's PYN/ID#. Mr. A is certifying the check himself. If mailed, Mr. B can swipe the magnetic stripe on the check into his CUPM or Credit card machine and press enter which will redeposit the check within the given period set by his bank.

Or can deposit the check at his bank, depending on the issuer.

Payer number (PYN): is a special standardize number (ID) or USFIN (Universal Standardize Financial Identification Number) that identify an individual anywhere in the world using Credsub or Disposable Financial Tools (DFT). It is use for financial transaction only e.g bank deposits, payment on credit accounts, loans and mortgage etc. or Identity theft account (ITA). The payee PYN will be on the back of his deposited check, and the payer PYN will be in front, replacing the account number to prevent the payee and payer from seeing each other account number, Avoiding check fraud. ATV Number: is a number used for activating checks or financial card.

Advantages: A single Subscribing credit plan for credit card and checking account without having to deposit a penny to cover a written check, and a credit card with cash advance check, no accruing interest on outstanding balance.

All checks are drawn against the licensed issuing company that issues the check. You can make a deposit without having the check, seeing the check or endorsing the check.

Certify a check without using a bank teller or entering the bank. Your account number will be none accessible to the public by using a PYN or USFIN.

Checkact allowed you to lock and unlock a check or financial card.

The line of credit must be approved before the account can be open.

No more writing of checks to be deposit into another account in order to use funs from the line of credit. All deposits and payments received are credited directly to the Lfee account.

By using reserved credit (bonus) or your account link to a credit card, there will be no bounce or returned checks, because of insufficient funs in your account or returned check fees unlike traditional checking accounts.

Credsub can be issued as a bundled service (Lfee and Lfee card). The use of the secondary card is limited to or can be used only by the account-holder for making payments with accounts that carry or link to his name and address only. Disposable card is limited to a single use only if stolen or the system is broken, by limiting its use, it makes it more secured than conventional credit card.

The account holder only uses the Ufix card number on the card instead of using the card itself. When making payments, the payer has the option of enter his utility account number and the 4 digits Lfee card number and amount, then press pay or entering the amount paying only. He will be limited to the account number and the amount he pays e.g. acc #: 3213 1111 2323 9067 is credited $50 with Lfee card # 9111. You can print the information as a receipt or your utility provider will give you a Pin number in order to access his account information, that's the only way he will see his name and address on the account.

The card only carry the number as a number holder, the card it self plays no part in the transaction, and has no real use other than carrying the account holder name and the number which can be optional.

Using the secondary card as a Utility card (Ufix) or Utility disposable card (UDcard) will prevent late payments on bills, save the account holder late payment fees, time spending in lines to pay bills, and cost less because no stamps are needed or checks to write. Payments are received the same time. And web purchases will be increase, because the UDcard is limited for a single use on any type of web purchase, that will take away fears of using a credit card on the web.

A mortgage card (Lfee M) is another way a homeowner can get a home equity loan without paying the high cost of getting a home equity loan. The card is issued against the down payment on the building.

Depending on the version (Lazy Check/Sleepy Check): Is process and approved with the payer electronic signature without using a paper check in the process.

A check holder no longer has to carry his checkbook or check; the check is always available where he goes to shop. The check is signs by the payer after it is process and approved as a form of receipt.

With a Lfee ID, you can purchase goods and services with a check (paperless check), have the check process, approved and get a copy of the used check without writing or providing an actual check. The check number on the printed receipt (check) will be a number not yet publish.

Lfee is a paperless electronic check that can be use Universally (Ucheck) or Global check (Go-check) with an electronic checkbook and more powerful than conventional check and checkbook. A regular Checkbook carries a limited amount of checks. Lfee ID automatically gives access to an unlimited amount of checks. An account holder can keep and using his Lfee ED without ordering new checks. Check numbers are architecture to be automatically when the Lfee ID is used.

Lfee does not carry an account number unlike conventional checking account Instead it uses a PYN. The PYN replacing the account number prevent the payee and payer from seeing each other account number. The PYN also link it to the account number. Check numbers are not followed in the numeral order, avoiding easy check fraud.

Lfee checks can be process and approved in front of the payee and payer within a minute or two electronically, without using a paper check depending on the version, avoiding a returned or bounce check, and the payee cash is in his account within 24 hours.

Lfee check can be deposit in an account any where in the world from any place. The account holder only needs the Country, bank name and account number of the recipient. When using a Lfee check as a Universa check (Ucheck), the payer will be limited to a fix amount e.g. $500 per transaction at a time.

Funs can be easily traced from account to account, when move electronically.

Deposit checks (Sent checks) can be canceled or the funs can be made unavailable to the recipient even if the funs are in foreign banks without the authorization of the foreign Government.

The account number will not be on the Lfee statements. The holder may use it to close or change information on the account. All processing/deposits and payments are made with the PYN.

Credsub is a credit system where by someone can apply for a fix amount of credit with a service plan, for a checking account, credit card account or a bundle service with credit card and cash advance check account. Account does not carry late payment fees if subscriber pays his monthly subscription fee. Lfee can be architecture with an automatic over draft and unemployment payment system.

1. The method of Conveniences Payment/CPAY: Making payment at a financial institution that issue's Credsub accounts, using Your PYN/ID, even if the issuer did not issue your account.

2. The method of Payer number (PYN): is a special/standardize financial number (ID) or USFIN (Universal Standardize Financial Identification Number) that identify an individual anywhere in the world using Credsub or Disposable Financial Tools (DFT).
It is also used for establishing accounts with banks and lenders.
when making bank deposits, it will be on the deposit slip and the back of a deposited check depending on the version, replacing the account number to prevent a the payee and payer from seeing each other account number, and someone that may come in contact with the check, avoiding fraudulent acts.
and with payment on accounts that are credited.

3-4. (canceled)

5. The method of Checkact: Is a security feature/process that act as a key to lock and unlock a check or financial card, allowing it to have access or from gaining access to the cash/credit in the account.
Using a serial number or ATV number to allowed the check/card number and total amount that is on the card or written on the check, to be available when the card is used or check is deposited.
Or make the cash/credit available for the specific card/check number to be used or drawn against or cleared.
When a check/card is activated the total amount activated will automatically be subtracted from the account.

6. (canceled)

7. The method of Escrow check (Certified check), a check Certified by the account holder himself without using a bank teller, and as a payee, you can deposit it, without seeing it, endorse it without touching it or without using a bank teller or entering the bank, and comes with a monthly subscription fee (Escrow fee).

8. The method of Lfee (Credsub) establishing an account with a line of credit that has no first in first out payment on outstand balance, with a credit card account is an a and a paperless Electronic Check with a checking account line of credit that does not increase year after year.
Checks numbers does not run in numeral order unlike regular checks e.g. 1012, 1013, 1014 and a paper check converted into a paperless check.
Credit is increase when Subscribers purchase or moved to higher plans and when bonuses are increase. Account does not carry any accruing interest on outstanding balance, but special offers with bonuses are allowed accruing interest when part or whole bonus is used.
There is no late payment fee if a subscriber pays his monthly subscription fee and do not pay on his outstanding balance.
The image of the check on the screen with the total amount payee name and the paver signature forming a completed paper less check, ready to be deposit with a single touch of a key by the payee or merchant without entering the Bank, and the process of Lfee check cash amount payee name, check number, account number or PYN/USFIN, payer name and signature sent to a clearing house check image, without the image of check itself to be processor.
Lfee (Subcheck) is can be process and approved in front of the paver within a minute or two electronically, without using a paper check as part of the process and avoiding a returned or bounce check.
The account holder can deposit a check in any account anywhere in the world from any place.
Sent checks can be canceled or the funs can be made unavailable to the recipient even if the funs are in foreign banks without the authorization of the foreign Government.

9-12. (canceled)

13. The method of Credsub subscribing credit plan (LaLoo plan) system, where by choosing credit with or without accruing interest on outstanding balances, with a limited/Tcredit for/to 3 years or unlimited life, for a credit card, checking account, and as a bundled service without any cash advance or transfer fee charges to the end user.
Accounts are setup or activated over the counter/store front by choosing a lender/issuer from a list of multiple lenders on the Lfee network and the account is renewable after the term.
Deposit made to start the account is none interest bearing none accessable or withdraw-able until the end of the term, but lenders may offer interest bearing as an option.
Deposits is used by a lender when there is an outstanding balance at the end the term.
Purchase bonus is used by the issuer to payoff outstanding balance at the end of the term or automatically become void if not used.

14. (canceled)

15. The method of Lazy Check (Sleepy Check): A is a paperless electronic check with the cash amount entered manually or scanned from a paper check.
When process and approved, a copy of the used check is printed in the form of a receipt that requires the payer signature as the only form of writing from the payer on the check, and it is done only after the check is process and approved.
The check is awaken and displayed when a Subcheck (Lfee) holder ID card, or check is scanned or the number on the paper check is entered manually and the enter button is press.
The ID is access an electronic checkbook dater base, allowing the check number to automatically appeared on the lazy check, with a number not yet publish on the holders paper check or check book.
With a Lfee ID, you can purchase goods and services with a check, have the check process, approved and get a copy of the used check without writing or providing an actual check.

16. The method of Lfee card Carrying a four-digit number or 3-10 digits, for general Internet transaction quarterly billing for subscription payment and ISP (Internet Service Providers), Utility and mortgage Company and the purchase of fixtures for the mortgaged home using a Ufix/static card number (utility fix card).

17. The method of Lfee card in two flavors, disposable (UD card), Ufix card number and a PYN/USFIN using a Lfee personal setup software dialer/connecter template as a security feature on any computer connect to the Internet, then double clicking the Lfee connecter/dialer icon and using a password or pin number, when login to the network, the PYN/USFIN and Ufix card number or PYN/USFIN displaying on the gateway template on a web site.
When making purchase at a web site and clicking Lfee prompting the personal Lfee software to pop up. Cardholder will choose the utility Companies he wants to pay, then enter the amount paving and press pay or enter account number, Utility card number and amount then press pay.
When issue as a mortgage card (Lfee m), it is issued or healed against the down pavement on the building.
The Lfee cash advance check amount links to a conventional checking account with zero monthly maintenance fee, to avoid penalty for accounts that are none transferable and is subtracted from credit line. The account will have automatic withdrawal from the amount allowed for cash advance checks and bonuses into the conventional account.
With deposit required to start an account ranging from $5, to 5% to 10% of the credit amount approved. line of credit must be approved before making the deposit or opening the conventional account, and the card is limited to or can only be used by the account-holder himself or authorize user for accounts that carry or link to his name and address.
And by making each card number different and linking it to a single PYN/USFIN which is also different, they can only work together when programmed together, if PYN/USFIN: 22214 is programmed for Ufix: # 9111. Ufix: 1295 would not work if not programed.
Only the card number is used in the transaction, not the card itself, merchant will not see payer account number at any time during the tansaction, so there is no need for a pin number, because the card only carry the 4 digits number as a number holder, not the account number or the holder's name, but it can be optional. The payer will be limited only to the account number and amount he pays, unless given a pin number by the payee (utility Company).
